(19) United States
(12) Patent Application Publication
(10) Pub. No.: US 2022/0034232 A1
(43) Pub. Date: Feb. 3, 2022

(54) APPARATUS FOR GENERATING ENERGY

(71) Applicant: Spar Energy LLC, Montvale, NJ (US)

(72) Inventor: Gaurav Bazaz, Montvale, NJ (US)

(73) Assignee: Spar Energy LLC, Montvale, NJ (US)

(21) Appl. No.: 17/390,471

(22) Filed: Jul. 30, 2021

Related U.S. Application Data
(60) Provisional application No. 63/058,488, filed on Jul. 30, 2020.

(51) Int. Cl. F01D 9/02; F01D 1/02

(52) U.S. Cl. CPC F01D 9/02; F01D 1/02

(57) ABSTRACT

An apparatus for generating energy through fluid dynamics includes a fluid reservoir, an energy extractor for extracting flow energy, a back-pressure control channel for circulating the fluid, and a pressure ejector for returning fluid to the fluid reservoir. The back-pressure control channel includes a fan-like device to generate a low-pressure region and draws fluid through the energy extractor. The energy extractor includes an energy extraction rotor to convert flow energy to rotation energy and may include a nozzle to alter flow characteristics of the fluid. The apparatus for generating energy may also include a settlement chamber to reduce flow disturbances.

### CROSS REFERENCE TO RELATED APPLICATION

This application claims priority to U.S. provisional patent application No. 63/058,488 filed Jul. 30, 2020, the contents of which are hereby incorporated by reference in their entirety.

### TECHNICAL FIELD

The present disclosure generally relates to an apparatus for generating energy, and more particularly relates to an apparatus for generating energy through the use of fluid dynamics.

### BACKGROUND

Renewable energy production is largely driven by wind and solar technologies. While these technologies enable clean energy production, they suffer from various shortcomings. One of the more important limitations is intermittency, which means they cannot be turned on or off as needed and depend on environmental factors such as availability of sunlight or wind flow in ideal speed range. Additionally, they cannot be easily sited at any location and are dependent on local climate. They also have a large area footprint, especially solar, for a given amount of power output. The present disclosure proposes to deliver renewable electric power while overcoming the various limitations of conventional wind and solar technologies. This innovation may enable non-polluting electric power that is dispatchable (turned on at any time as needed), non-intermittent (can run as baseload power), highly scalable, with a small footprint, and locatable to any geography.

### SUMMARY

The following presents a simplified summary of various aspects of this disclosure in order to provide a basic understanding of such aspects. This summary is not an extensive overview of the disclosure. It is intended to neither identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

In an aspect of the present disclosure, an apparatus for generating energy using fluid dynamics is provided. The apparatus for generating energy includes a reservoir containing or consisting of a fluid. The fluid may be one of air, water, oil, nitrogen or another Newtonian fluid or mixture of Newtonian fluids. The apparatus for generating energy includes an energy extractor for extracting energy from the fluid. The energy extractor may include an energy extraction rotor. The apparatus for generating energy includes a back-pressure control channel to maintain closed-loop circulation of the fluid while forming a low-pressure region. The back-pressure channel may include a fan-like device for maintaining closed-loop circulation. The apparatus for generating energy includes a pressure ejector for returning the fluid to the reservoir.

In another aspect of the present disclosure, the energy extractor may include a nozzle for altering flow characteristics of the fluid. The nozzle may include a section of variable cross-section, in order to form either of a convergent or convergent-divergent shape. The variable cross-section may be configured to increase the flow velocity of the fluid to subsonic or supersonic velocities.

In another aspect of the present disclosure, an apparatus for generating energy is provided. The apparatus for generating energy includes a settlement chamber between the energy extractor and the back-pressure channel for minimizing deleterious flow effects in the fluid.

In another aspect of the present disclosure, the apparatus for generating energy may include additional energy extractors and pressure ejectors. The pressure ejectors may be configured in a series arrangement or a parallel arrangement.

### BRIEF DESCRIPTION OF THE DRAWINGS

The present disclosure is illustrated by way of example, and not by way of limitation, in the figures of the accompanying drawings, in which:

FIG. 1 illustratively depicts an apparatus for generating energy, in accordance with an implementation of the disclosure;

FIG. 2 illustratively depicts an apparatus for generating energy, in accordance with another implementation of the disclosure;

FIG. 3 illustratively depicts a first view detailing an apparatus for generating energy, in accordance with an implementation of the disclosure;

FIG. 4 illustratively depicts a second view detailing an apparatus for generating energy, in accordance with an implementation of the disclosure;

FIG. 5 illustratively depicts a third view detailing an apparatus for generating energy, in accordance with an implementation of the disclosure;

FIG. 6 illustratively depicts a fourth view detailing an apparatus for generating energy, in accordance with an implementation of the disclosure;

FIG. 7 illustratively depicts a fifth view detailing an apparatus for generating energy, in accordance with an implementation of the disclosure;

FIG. 8 illustratively depicts a sixth view detailing an apparatus for generating energy, in accordance with an implementation of the disclosure;

FIG. 9 illustratively depicts a seventh view detailing an apparatus for generating energy, in accordance with an implementation of the disclosure;

FIG. 10 illustratively depicts an eighth view detailing an apparatus for generating energy, in accordance with an implementation of the disclosure; and

FIG. 11 illustratively depicts a ninth view detailing an apparatus for generating energy, in accordance with an implementation of the disclosure.

### DETAILED DESCRIPTION

Before the present subject matter is described in detail, it is to be understood that this disclosure is not limited to the particular implementations described, as such may vary. It should also be understood that the terminology used herein is to describing particular implementations only, and is not intended to be limiting, since the scope of the present disclosure will be limited only by the appended claims. While this disclosure is susceptible to different implementations in different forms, there is shown in the drawings and will here be described in detail a preferred implementation of the disclosure with the understanding that the present disclosure is to be considered as an exemplification of the principles of the disclosure and is not intended to limit the broad aspect of the disclosure to the implementation illustrated. All features, elements, components, functions, and steps described with respect to any implementation provided herein are intended to be freely combinable and substitutable with those from any other implementation unless otherwise stated. Therefore, it should be understood that what is illustrated is set forth only for the purposes of example and should not be taken as a limitation on the scope of the present disclosure.

In the following description and in the figures, like elements are identified with like reference numerals. The use of “e.g.,” “etc.,”, “or” and “the like” indicates non-exclusive alternatives without limitation, unless otherwise noted. The use of “having”, “comprising”, “including” or “includes” means “including, but not limited to,” or “includes, but not limited to,” unless otherwise noted.

Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “comprising” can refer, in one implementation, to A only (optionally including entities other than B); in another implementation, to B only (optionally including entities other than A); in yet another implementation, to both A and B (optionally including other entities). These entities may refer to elements, actions, structures, steps, operations, values, and the like.

The primary phenomena utilized to operate this system include entrainment, Venturi acceleration and conversion between dynamic and static pressure. Entrainment is the phenomenon whereby a flowing fluid undergoes a static pressure drop relative to baseline static pressure due to constriction of flow channels and thereby draws in nearby fluid with higher static pressure and this drawn-in fluid starts flowing with the initial flowing fluid. Venturi acceleration is the process whereby a fluid driven through a constricting channel experiences an acceleration and static pressure drop.

The interconvertibility of static and dynamic pressure is defined in Bernoulli's laws and refers to the fact that fluids convert their static pressure to dynamic pressure and back to static pressure under variations of flow area, while maintaining a constant total energy, excluding losses. Additionally, the total pressure of a fluid at any given moment is the sum of its static pressure and dynamic pressure. Lastly, various known methods are available for reducing losses a fluid experiences when flowing through channels. Principles noted above are used in various systems such as eductor pumps, aspirators, and nozzles.

Known physical phenomena such as entrainment and Venturi acceleration are used to draw stationary ambient fluid into a flow field, thereby converting the static pressure energy of the stationary fluid into usable kinetic energy. This kinetic energy is driven through a turbine to draw electric power, and the exhaust flow is returned to the reservoir.

While the apparatus and method described here apply to most Newtonian fluids, the description mostly uses atmospheric air as the exemplar fluid. Nevertheless, the disclosure here applies to other Newtonian fluids as well, and not just atmospheric air.

Various aspects of the above referenced system are described in detail herein by way of examples, rather than by way of limitation.

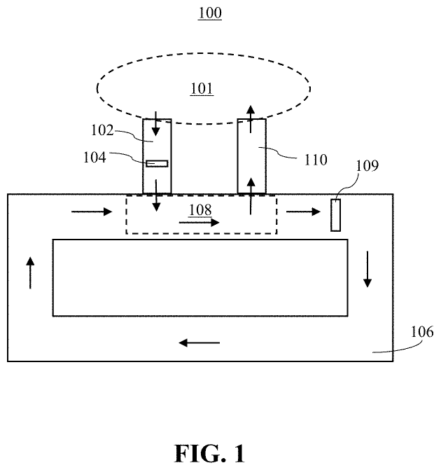

FIG. 1 illustratively depicts an apparatus for generating energy 100. The apparatus for generating energy 100 includes a fluid reservoir 101, an energy extractor 102, a back-pressure control channel 106, and a pressure ejector 110. The energy extractor 102 includes an energy extraction rotor 104. The back-pressure control channel 106 includes a low-pressure region 108 and a fan-like device 109.

The apparatus for generating energy 100 is in fluid contact with a fluid reservoir 101, from which a fluid is drawn in through the energy extractor 102 and into which the fluid is returned via the pressure ejector 110. The fluid reservoir 101 may be a constrained quantity of fluid or may be an ambient source. The fluid may be any of air, water, oil, nitrogen, or another Newtonian fluid.

The back-pressure control channel 106 may be a channel coupled to the energy extractor 102 that runs as a closed loop wherein the fluid may circulate. The fan-like device 109 drives the fluid to move within the back-pressure control channel 106, and once in motion it is expected to provide only the minimum incremental energy to make up for the energy losses the fluid experiences in motion. The fan-like device 109 may be a device configured to circulate the fluid and to form a low-pressure region 108 in response to rotation. In an implementation, the fan-like device 109 is driven by an electric motor. In another implementation, the fan-like device 109 is driven by a mechanical belt, a gear, or a crank.

In an implementation, the back-pressure control channel 106 also has a narrow section (not shown) wherein the flow experiences acceleration per the laws of Bernoulli and more broadly the laws of isentropic flow. That is, as the fluid moving in the back-pressure control channel 106 experiences a narrowing channel, it speeds up to maintain the same flow rate. The acceleration of the fluid is expected to result in a drop in static pressure of the fluid through the conversion of a portion of the static pressure to dynamic pressure. This drop in static pressure is expected to form a low-pressure region 108 in back-pressure control channel 106. It is expected that the low-pressure region 108 will fluctuate in size and shape in accordance with eddies and inconsistencies in flow. The fluid within the back-pressure control channel 106 may be the same fluid as that supplied by the fluid reservoir 101 or a different fluid initially.

In an implementation, the primary role of the back-pressure control channel 106 is to form a low-pressure region 108 and maintain it for the duration of operation of the system. At the same time, since the back-pressure control channel 106 may be powered by a fan-like device 109 which draws power, the back-pressure control channel 106 may be configured to minimize the power required by the fan-like device 109.

Since the power draw of the fan-like device 109 may be influenced by the energy losses experienced by the looping flow within the back-pressure control channel 106, minimizing these energy losses is expected to result in minimization of the power draw of the fan-like device 109. Loss minimization steps may include minimizing turbulence at corner bends, selecting the fan-like device 109 based upon its ideal operating point, minimizing surface friction losses, as well as preventing and minimizing flow separation at relevant sections.

In an implementation, once the fluid in the back-pressure control channel 106 begins to circulate, the low-pressure region 108 forms near the opening of the energy extractor 102. The low-pressure region 108 represents a pressure differential between the fluid reservoir 101 and the circulating fluid in the back-pressure control channel 106. In an implementation, the energy extractor 102 is connected to the fluid reservoir 101. This pressure differential is expected to initiate flow from fluid reservoir 101, through the energy extractor 102 and energy extraction rotor 104, and into the back-pressure control channel 106 in response to the low-pressure region 108. It is expected that molecular entrainment in the back-pressure control channel 106 will maintain the low-pressure region 108 and, thus, the resulting flow. With appropriate fluid flow control, the incoming fluid may be redirected to join the internal circulation fluid as an outer layer with minimal turbulence.

As the fluid flows through the energy extractor 102, a portion of its energy may be converted to work by the energy extraction rotor 104. In an implementation, the energy extraction rotor 104 is configured for extracting energy from the fluid by rotating in response to fluid flow. As the energy extraction rotor 104 rotates, a set of magnetic windings (not shown) may be employed to convert rotation energy to electric energy. It is expected that, after passing through the energy extraction rotor 104, the fluid will have lower energy than the internal looping fluid and this is expected to manifest as a lower total pressure.

Once this entrained fluid from the energy extractor 102 is stable within the back-pressure control channel 106, the fluid may be physically directed to enter the pressure ejector 110 through use of geometric surfaces (not shown) which direct the flow. Since the entrained fluid forms an outer layer around the internal looping flow, it may be cleanly scooped out with appropriate flow control surfaces and redirected into a pressure ejector 110 coupled to the back-pressure control channel 106.

The primary role of the pressure ejector 110 may be to return the fluid to the fluid reservoir 101. It is expected that under ideal operation the pressure ejector 110 will capture all of the fluid entering via the energy extractor 102 and eject all its captured flow back to the fluid reservoir 101 by raising the total pressure of the flow it receives. In some cases, the pressure ejector 110 may also be a direct outlet whereby the dynamic pressure of the entrained flow is itself sufficient to overcome the higher static pressure of the fluid reservoir 101.

In an implementation, the pressure ejector 110 effectively raises the total pressure of this entrained lower total pressure flow by trapping the fluid against a wall. As waves of entrained flow enter the pressure ejector 110, the additional fluid is expected to raise total pressure like a pump, enabling the ejection of the entrained flow back to the fluid reservoir 101.

In an implementation (not shown), the apparatus for generating energy 100 may include one or more additional back-pressure control channels 106, energy extractors 102, and/or pressure ejectors 110 in any combination thereof, mutually coupled in the same relative arrangement.

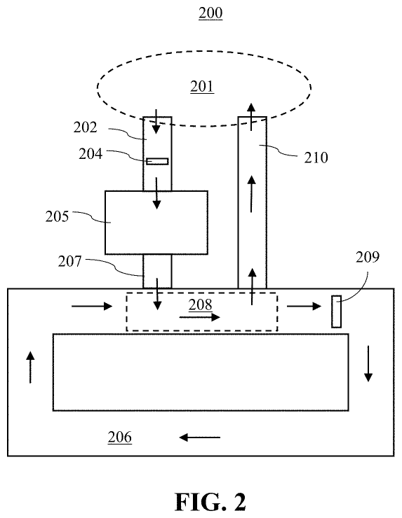

Fluid traveling from the energy extractor 102 to the back-pressure control channel 106 may first pass through an energy extractor (“ET”) to back-pressure control channel (“BPCC”) interconnect (not shown), hereafter referred to as an “ET-BPCC interconnect.” The ET-BPCC interconnect is expected to ensure a smooth transition of flow from the energy extractor 102 to the back-pressure control channel 106. As used herein, “ETPE complex” means the region of the apparatus for generating energy 100 containing the ET-BPCC interconnect (not shown) and the connection between the back-pressure control channel 106 and the pressure ejector 110. As depicted in FIG. 2 and described below, the ET-BPCC interconnect may also be configured to minimize turbulence and flow separation so as to minimize losses.

FIG. 2 illustratively depicts an apparatus for generating energy 200 in accordance with another implementation of the present disclosure. The apparatus for generating energy 200 includes a fluid reservoir 201, an energy extractor 202, a settlement chamber 205, a back-pressure control channel 206, an ET-BPCC interconnect 207, and a pressure ejector 210. The energy extractor 202 includes an energy extraction rotor 204. The back-pressure control channel 206 includes a low-pressure region 208 and a fan-like device 209.

The apparatus for generating energy 200 is in fluid contact with a fluid reservoir 201, from which a fluid is drawn in through energy extractor 202 and into which the fluid is returned via the pressure ejector 210. The fluid reservoir may be a constrained quantity of fluid or may be an ambient source. The fluid may be any of air, water, oil, nitrogen, or another Newtonian fluid.

The fluid may be circulated in the back-pressure control channel 206 in such a way that the flow channel constricts to a smaller cross-sectional area in one region, thereby causing the fluid to reduce its static pressure while gaining dynamic pressure as per Bernoulli's law. This is expected to form a low-pressure region 208 at the region where the back-pressure control channel 206 constricts. In an implementation, the low-pressure region 208 is in contact with the ET-BPCC interconnect 207. The fluid within the back-pressure control channel 206 may be the same fluid as that supplied by the fluid reservoir 201 or a different fluid initially.

The back-pressure control channel 206 may be a channel that runs as a closed loop wherein the fluid may circulate. The fan-like device 209 drives the fluid to move within the back-pressure control channel 206, and once in motion it is expected to provide only the minimum incremental energy to make up for the energy losses the fluid experiences in motion. The fan-like device 209 may be a device configured to induce flow of a fluid in response to rotation. In an implementation, the fan-like device 209 is driven by an electric motor. In another implementation, the fan-like device 209 is driven by a mechanical belt, a gear, or a crank.

In an implementation, the back-pressure control channel 206 also has a narrow section (not shown) wherein the flow experiences acceleration per the laws of Bernoulli and more broadly the laws of isentropic flow. That is, as the fluid moving in the back-pressure control channel 206 loop experiences a narrowing channel, it speeds up to maintain the same flow rate. The acceleration of the fluid is expected to result in a drop in static pressure of the fluid through the conversion of a portion of the static pressure to dynamic pressure. This drop in static pressure is expected to form a low-pressure region 208 in the back-pressure control channel 206. The fluid within the back-pressure control channel 206 may be the same fluid as that supplied by the fluid reservoir 201 or a different fluid initially.

In an implementation, once the fluid in back-pressure control channel 206 begins to circulate, a low-pressure region 208 forms near the opening of the ET-BPCC interconnect 207. The low-pressure region 208 represents a pressure differential between the fluid reservoir 201 and the circulating fluid in the back-pressure control channel 206. This pressure differential is expected to initiate flow from the fluid reservoir 201, through the energy extractor 202 and the energy extraction rotor 204, through the settlement chamber 205 and ET-BPCC interconnect 207, and into the back-pressure control channel 206 in response to the low-pressure region 208. With appropriate fluid flow control, the incoming fluid may be redirected to join the internal circulation fluid as an outer layer with minimal turbulence.

As the fluid flows through the energy extractor 202, a portion of its energy may be converted to work by the energy extraction rotor 204. In an implementation, the energy extraction rotor 204 is configured to rotate in response to fluid flow. As the energy extraction rotor 204 rotates, a set of magnetic windings (not shown) may be employed to convert rotation energy to electric energy. It is expected that, after passing through the energy extraction rotor 204, the fluid will have lower energy than the internal looping fluid and this is expected to manifest as a lower total pressure.

The settlement chamber 205 is expected to act as a buffer between the energy extraction rotor 204 and the low-pressure region 208. As the fluid emerges from the energy extraction rotor 204 inside the energy extractor 202, the fluid is expected to carry various flow instabilities and disturbances such as vortices and turbulence. When these flow instabilities enter the back-pressure control channel 206, they can cause various disruptions and losses.

In an implementation, the settlement chamber 205 allows the flow downstream of the energy extraction rotor 204 to come to a near complete stop, which is expected to cause all the instabilities to be attenuated substantially and local turbulent kinetic energy to be reconverted to static pressure energy. As a result, the low-pressure region 208 inside the back-pressure control channel 206 may draw the fluid from the settlement chamber 205 through the ET-BPCC interconnect 207 as if it were drawing it from a stationary volume of fluid. This may minimize losses and improve the performance of the apparatus for generating energy 200. The settlement chamber 205 may also allow various complex flows such as vortices, wakes and local shocks to be dissipated and recovered as static pressure and minimize the impact of turbine action on flow dynamics into the back-pressure control channel 206.

Once the entrained fluid from the energy extractor 202 is stable within the back-pressure control channel 206, the fluid may be physically directed to enter the pressure ejector 210 through use of geometric surfaces (not shown) which direct the flow. Since the entrained fluid forms an outer layer around the internal looping flow, it may be cleanly scooped out with appropriate flow control surfaces and redirected into the pressure ejector 210.

In an implementation, the pressure ejector 210 effectively raises the total pressure of this entrained lower total pressure flow by trapping the fluid against a wall. As waves of entrained flow enter the pressure ejector 210, the additional fluid is expected to raise total pressure like a pump, enabling the ejection of the entrained flow back to the fluid reservoir 201.

Additional details regarding individual components of the apparatus for generating energy 100 and apparatus for generating energy 200 are described below.

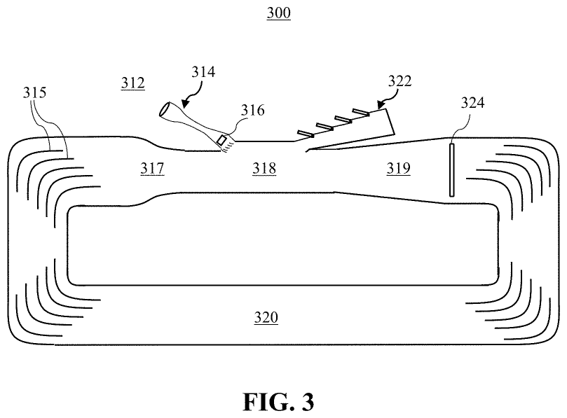

FIG. 3 illustratively depicts a first view detailing an apparatus for generating energy 300. The apparatus for generating energy 300 includes an ambient fluid 312, an energy extractor 314, a back-pressure control channel 320, and a pressure ejector 322 (also referred to as “PE”). The energy extractor 314 includes a turbine 316. The back-pressure control channel 320 includes corner vanes 315, a BPCC contraction 317, a low-pressure region 318, a BPCC diffuser 319, and a fan 324.

The apparatus for generating energy 300 may include all or portions of the component(s) of the apparatus for generating energy 100 depicted in FIG. 1 and described above.

The apparatus for generating energy 300 is in fluid contact with a fluid reservoir (not shown), from which an ambient fluid 312 is drawn in through energy extractor 314 and into which the ambient fluid 312 is returned via pressure ejector 322. The ambient fluid 312 may be any of air, water, oil, nitrogen, or another Newtonian fluid. The fluid within the back-pressure control channel 320 may be the same fluid as that supplied by the ambient fluid 312 or a different fluid initially.

The back-pressure control channel 320 may be a channel that runs as a closed loop wherein the fluid may circulate. The fan 324 drives the fluid to move within the back-pressure control channel 320, and once in motion it is expected to provide only the minimum incremental energy to make up for the energy losses the fluid experiences in motion. The fan 324 may be a device configured to induce flow of a fluid in response to rotation. In an implementation, the fan 324 is driven by an electric motor. In another implementation, the fan 324 is driven by a mechanical belt, a gear, or a crank.

In an implementation, the back-pressure control channel 320 also include a back-pressure control channel (“BPCC”) contraction 317 wherein the flow experiences acceleration per the laws of Bernoulli and more broadly the laws of isentropic flow. That is, as the fluid moving in the back-pressure control channel 320 flows into the BPCC contraction 317, it speeds up to maintain the same flow rate. The acceleration of the fluid is expected to result in a drop in static pressure of the fluid through the conversion of a portion of the static pressure to dynamic pressure. This drop in static pressure is expected to form a low-pressure region 318 in back-pressure control channel 320.

The working mechanism follows the abstract model described in FIG. 1. The fluid in the back-pressure control channel 320 and the ambient fluid 312 are at pressure equilibrium initially, such that both fluid reservoirs are mutually stationary and at same static pressure. In an implementation, fan 324 causes the fluid in the back-pressure control channel 320 to start circulating in a loop, such that a control volume of fluid passes through the BPCC contraction 317 first, then through the low-pressure region 318 and finally through the BPCC diffuser 319.

As this fluid circulates in a loop, it passes through the BPCC contraction 317 whereby it converts some of its static pressure to dynamic pressure, resulting in an increase in the fluid flow velocity and reduction in its static pressure, and resulting in the formation of a low-pressure region 318 (or “LPR”) in the throat of the back-pressure control channel 320. The low-pressure region 318 is expected to cause a pressure difference to form between the back-pressure control channel 320 and the ambient fluid 312, which is at relative rest.

The pressure difference at the interface of the low-pressure region 318 in the back-pressure control channel 320 and the ambient fluid 312, experienced at the point where the energy extractor 314 connects with the back-pressure control channel 320, is expected to result in stationary ambient fluid being entrained and starting to move into the back-pressure control channel 320 through the energy extractor 314. The initiation of this flow from the energy extractor 314 is expected to result in ambient fluid passing through the energy extractor 314 and as a result passing through the turbine 316. As the flow passes through the turbine 316, it is expected to cause the turbine 316 to spin and produce electric power in combination with a generator (not shown).

The flow passing through the energy extractor 314 can be accelerated to enhance the performance of the turbine 316 through the use of a nozzle-like contraction in the energy extractor 314. Once the entrained flow exits from the energy extractor 314 and enters the back-pressure control channel 320, various flow control surfaces and ducts may cause the flow to mix smoothly with the looping fluid flowing within back-pressure control channel 320. Also, since the fluid flow from the energy extractor 314 enters from the outside, it is expected to form an outer layer around the back-pressure control channel 320 looping flow.

When this entrained fluid from the energy extractor 314 reaches the pressure ejector 322, barriers and control surfaces direct the entrained fluid to enter the pressure ejector 322, while allowing the internal circulating fluid to continue circulating within the back-pressure control channel 320. Through optimization of design and use of actuators to dynamically control the flow control surfaces at the ET-BPCC interface and BPCC-PE interface, one may optimize the flow such that almost all of the entrained flow from the energy extractor 314 enters the pressure ejector 322, while almost none of the looping flow in the back-pressure control channel 320 enters the pressure ejector 322.

The entrained flow then is expected to pass through the pressure ejector 322 and eventually to reach the end of the pressure ejector 322 where it may be trapped. As entrained flow from the energy extractor 314 continuously enters the pressure ejector 322, the entrained flow is expected to cause the total pressure of the fluid that has already entered the pressure ejector 322 to rise in a pump-like action. The pressure eventually may rise sufficiently to force the fluid out from the outlets at the top of the pressure ejector 322. This is expected to result in the entrained low total pressure flow from the energy extractor 314 to be returned back to the ambient fluid 312.

In an implementation, the internal circulating fluid of the back-pressure control channel 320 continues to circulate in the back-pressure control channel 320 in an endless loop as long as the fan 324 is operating. The energy drawn from the turbine 316 is a function of the total fluid flow rate through the turbine 316 drawn from the ambient fluid 312 and the pressure differential between the ambient fluid 312 and the low-pressure region 318. In an implementation, the greater the flow rate of entrained flow and greater the pressure difference that is created, the more power that may be generated by the turbine 316.

In an implementation, the power consumed by the apparatus for generating energy 300 is a function of the losses experienced by the looping fluid in the back-pressure control channel 320. In this implementation, the lower the losses, the less power needs to be supplied by the fan 324 to keep the fluid circulating at a target speed and pressure. By maximizing the flow rate of the flow through the energy extractor 314, and therefore the turbine 316, and maximizing the pressure difference between the ambient fluid 312 and the low-pressure region 318 while minimizing the losses experienced by circulating fluid in back-pressure control channel 320, one may enable a larger power output from turbine 316 than power input to the fan 324.

Within the back-pressure control channel 320, the BPCC diffuser 319 may help return the high-speed, low static pressure flow in the throat to low-speed, high static pressure flow at the end of the BPCC diffuser 319. In an implementation, losses can be minimized in this dynamic pressure to static pressure conversion. Additionally, the corner vanes 315 help direct the flow around the corners of the back-pressure control channel 320 in an efficient manner so as to minimize the losses around the turns. Finally, to stop the system from operation, the fan 324 may be switched off.

As noted earlier, to prevent reverse direction flow from the pressure ejector 322, when the system is started, the pressure ejector 322 may be sealed off from the back-pressure control channel 320 until the entrained flow from the energy extractor 314 fully develops. Once the entrained flow from the energy extractor 314 fully develops, the seal (not shown) between pressure ejector 322 and the back-pressure control channel 320 may be opened up and the fully developed entrained flow from the energy extractor 314 is expected to flow into the pressure ejector 322 in the intended direction and eventually exit back to the ambient fluid 312.

Additionally, the back-pressure control channel 320 may also include a BPCC diffuser 319 wherein the cross-section of the back-pressure control channel 320 increases. In an implementation, the BPCC diffuser 319 is configured to decelerate the fluid, and consequently raise its static pressure, before the fluid reaches the fan 324. The decelerated fluid then may be accelerated mechanically by the action of the fan 324.

In an implementation, the back-pressure control channel 320 includes various flow control surfaces and ducts such as corner vanes 315 to cause the flow to move smoothly with the looping path of the back-pressure control channel 320. Also, since the entrained fluid flow from the energy extractor 314 through the turbine 316 enters from the outside, it is expected to form an outer layer around the looping fluid flow already present in the back-pressure control channel 320.

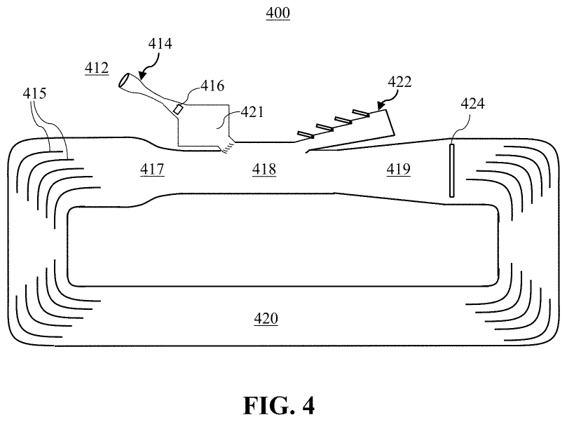

FIG. 4 illustratively depicts a second view detailing an apparatus for generating energy 400 in accordance with another implementation of the present disclosure. The apparatus for generating energy 400 includes an ambient fluid 412, an energy extractor 414, a back-pressure control channel 420, a settlement chamber 421, and a pressure ejector 422. The energy extractor 414 includes a turbine 416. The back-pressure control channel 420 includes a BPCC contraction 417, a low-pressure region 418, a BPCC diffuser 419, and a fan 424, as well as corner vanes 415

The apparatus for generating energy 400 may include all or portions of the component(s) of the apparatus for generating energy 200 depicted in FIG. 2 and described above.

The apparatus for generating energy 400 is in fluid contact with a fluid reservoir (not shown), from which an ambient fluid 412 is drawn in through energy extractor 414 and into which the ambient fluid 412 is returned via pressure ejector 422. The ambient fluid 412 may be any of air, water, oil, nitrogen, or another Newtonian fluid.

The back-pressure control channel 420 may be a channel that runs as a closed loop wherein the fluid may circulate. The fan 424 drives the fluid to move within the back-pressure control channel 420, and once in motion it is expected to provide only the minimum incremental energy to make up for the energy losses the fluid experiences in motion. The fan 424 may be a device configured to induce flow of a fluid in response to rotation. In an implementation, the fan 424 is driven by an electric motor. In another implementation, the fan 424 is driven by a mechanical belt, a gear, or a crank.

In an implementation, the back-pressure control channel 420 also include a back-pressure control channel (“BPCC”) contraction 417 wherein the flow experiences acceleration per the laws of Bernoulli and more broadly the laws of isentropic flow. That is, as the fluid moving in the back-pressure control channel 420 flows into the BPCC contraction 417, it speeds up to maintain the same flow rate. The acceleration of the fluid is expected to result in a drop in static pressure of the fluid through the conversion of a portion of the static pressure to dynamic pressure. This drop in static pressure is expected to form a low-pressure region 418 in back-pressure control channel 420.

Conversely, the back-pressure control channel 420 may also include a BPCC diffuser 419 wherein the cross-section of the back-pressure control channel 420 increases. In an implementation, the BPCC diffuser 419 is configured to decelerate the fluid, and consequently raise its static pressure, before the fluid reaches the fan 424. The decelerated fluid then may be accelerated mechanically by the action of the fan 424.

In an implementation, the back-pressure control channel 420 includes various flow control surfaces and ducts such as corner vanes 415 to cause the flow to move smoothly with the looping fluid flowing within the back-pressure control channel 420. Also, since the fluid flow from the energy extractor 414 through the turbine 416 enters from the outside, it is expected to form an outer layer around the looping fluid flow already present in the back-pressure control channel 420.

The settlement chamber 421 is expected to act as a buffer between the turbine 416 and the low-pressure region 418. As the fluid emerges from the turbine 416 inside the energy extractor 414, the fluid is expected to carry various flow instabilities and disturbances such as vortices and turbulence. When these flow instabilities enter the back-pressure control channel 420, they can cause various disruptions and losses.

In an implementation, the settlement chamber 421 allows the flow downstream of the turbine 416 to come to a near complete stop, which is expected to cause all the instabilities to be attenuated substantially and local turbulent kinetic energy to be reconverted to static pressure energy. As a result, the low-pressure region 418 inside the back-pressure control channel 420 may draw the fluid from the settlement chamber 421 as if it were drawing it from a stationary volume of fluid. This may minimize losses and improve the performance of the apparatus for generating energy 400. The settlement chamber 421 may also allow various complex flows such as vortices, wakes and local shocks to be dissipated and recovered as static pressure and minimize the impact of turbine action on flow dynamics into the back-pressure control channel 420.

The settlement chamber 421 acts as a buffer between the turbine 416 and the low-pressure region 418. When the flow emerges from the turbine 416, it is expected to carry various instabilities and disturbances such as vortices and turbulence. When these flow instabilities enter the back-pressure control channel 420, the flow instabilities may cause various disruptions and losses which may impact the performance of the system unfavorably. The settlement chamber 421 allows the flow downstream of the turbine 416 to come to a near complete stop, which allows the instabilities to be attenuated and local turbulent kinetic energy to be reconverted to static pressure energy.

As a result, the low-pressure region 418 inside the back-pressure control channel 420 is able to draw the fluid from the settlement chamber 421 in such a manner as if it were drawing it from a stationary reservoir of the fluid. This is expected to minimize losses and allow target performance by the system. At the same time, since the low-pressure region 418 may draw fluid from the settlement chamber 421, the low-pressure region 418 may cause the settlement chamber 421 in turn to draw fluid through the turbine 416, via the energy extractor 414 and eventually from the ambient fluid 412.

In an implementation, the working mechanism of FIG. 4 is substantially similar to or the same as the one described above with respect to FIG. 3, with the exception of the addition of the settlement chamber 421 described above.

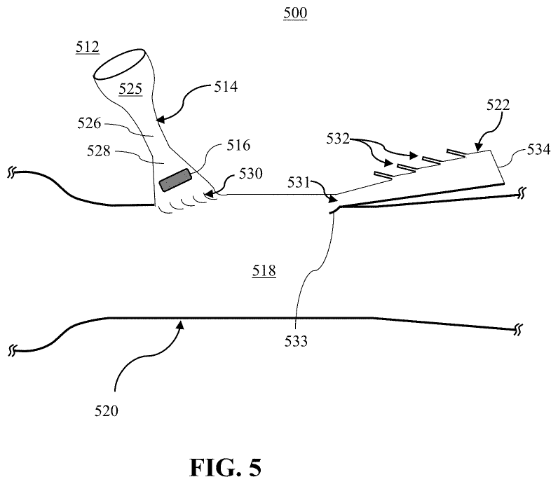

FIG. 5 illustratively depicts a third view detailing an apparatus for generating energy 500. FIG. 5 depicts a close-up view of some aspects of FIG. 1 and/or FIG. 3. Specifically, FIG. 5 depicts an ET-BPCC interconnect and adjacent components. The apparatus for generating energy 500 includes an ambient fluid 512, an energy extractor 514, a back-pressure control channel 520, and a pressure ejector 522. The energy extractor 514 includes a turbine 516, an ET nozzle-contraction 525, an ET nozzle-throat 526, an ET-diffuser 528, and flow director vanes 530. The back-pressure control channel 520 includes a low-pressure region 518. The pressure ejector 522 includes a PE inlet 531, PE outlets 532, a PE guide vane 533, and a capping wall 534.

The apparatus for generating energy 500 may include all or portions of the component(s) of the apparatus for generating energy 100 and/or the apparatus for generating energy 300 depicted in FIG. 1 and FIG. 3, respectively, and described above.

The apparatus for generating energy 500 is in fluid contact with a fluid reservoir (not shown), from which an ambient fluid 512 is drawn in through energy extractor 514 and into which the ambient fluid 512 is returned via pressure ejector 522. The ambient fluid 512 may be any of air, water, oil, nitrogen, or another Newtonian fluid.

In an implementation, the low-pressure region 518 causes inflow of ambient fluid 512 through the energy extractor 514. The initial impetus caused by this inflow is expected to result in some of the static pressure of the ambient fluid 512 converting to dynamic pressure. In an implementation, the energy extractor 514 includes a nozzle with a variable cross-section. In one implementation, the cross-section of the nozzle decreases or contracts along the length of the nozzle and is called “convergent.” In an alternative implementation, the cross-section of the nozzle first decreases or contracts and then increases along the length of the nozzle and is called “convergent-divergent.”

The ambient fluid 512 enters through the ET nozzle-contraction 525, where the convergent nozzle is expected to cause the flow to accelerate further substantially. In an implementation, the ET nozzle-contraction 525 is configured to cause the fluid to flow at a subsonic (or less than the speed of sound in air) rate. In an implementation, the ET-diffuser 528 (or nozzle divergent section) is configured to cause the fluid to flow at a subsonic velocity. In an alternative implementation, the ET-diffuser 528 (nozzle divergent section) is configured to cause the fluid to flow at a supersonic (greater than local speed of sound) velocity. This flow acceleration in the energy extractor 514 may convert an additional portion of the static pressure of the previously stationary fluid to dynamic pressure. The entrained flow passes through the ET nozzle-throat 526 and enters the ET-diffuser 528 from where it exits.

In an implementation, the entrained flow passes through the turbine 516 causing it to rotate. The turbine 516 may be placed anywhere in the energy extractor 514 downstream of the ET nozzle-throat 526. When the turbine 516 rotates, it is expected to convert some of the dynamic pressure of the entrained flow to mechanical work, which may then be converted to electric power by a connected generator. As a result of this conversion, the entrained flow loses some of its kinetic energy, which manifests as lower dynamic pressure and lower total pressure.

Once past the turbine 516, the entrained fluid may pass through flow director vanes 530. In an implementation, the flow director vanes 530 redirect the entrained flow to smoothly join the back-pressure control channel 520 flow in the low-pressure region 518. This entrained flow once inside the back-pressure control channel 520 travels along the path of the internal looping flow as an outer layer and eventually reaches the PE inlet 531. At the PE inlet 531, PE guide vanes 533 may direct the entrained flow into the pressure ejector 522. The PE guide vanes 533 and flow director vanes 530 may be mounted on actuators (not shown) so they adjust the fluid flows dynamically to optimize flow to required parameters. Primarily, the flow director vanes 530 are expected to optimize for the intermixing of the entrained flow from energy extractor 514 into the back-pressure control channel 520, so as to minimize the turbulence. The PE guide vanes 533 may optimize to capture maximum of the entrained flow coming from energy extractor 514. Further, the PE guide vanes 533 may minimize the mass of the looping flow within the back-pressure control channel 520 entering the pressure ejector 522. In an implementation, the PE guide vanes 533 prevent any of the looping flow within back-pressure control channel 520 from entering the pressure ejector 522.

In an implementation, the pressure ejector 522 is a channel with a capping wall 534 at the end. The entrained flow now entering the pressure ejector 522 may crash into the capping wall 534 to at least momentarily trap and delay the fluid as it returns to the reservoir of ambient fluid 512. This trapped fluid in the pressure ejector 522 experiences an elevating total pressure inside the pressure ejector 522 due to the waves of incoming fluid running into the capping wall 534 barrier, which enables the fluid to exit back to the reservoir of ambient fluid 512 through the PE outlets 532. The entrained flow thus completes a full cycle from reservoir of ambient fluid 512, through the energy extractor 514 and turbine 516, into the back-pressure control channel 520 through its low-pressure region 518, into the pressure ejector 522, and finally back to the reservoir of ambient fluid 512.

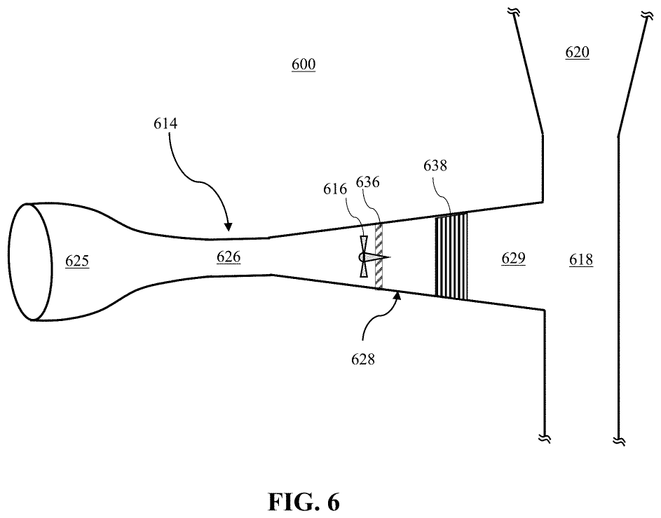

FIG. 6 illustratively depicts a second view detailing an apparatus for generating energy 600. FIG. 6 depicts a close-up view of some aspects of FIG. 1 and/or FIG. 3. Specifically, FIG. 6 depicts a close-up view of an energy extractor and adjacent components. The apparatus for generating energy 600 includes an energy extractor 614 and a back-pressure control channel 620. The energy extractor 614 includes a turbine 616, an ET nozzle-contraction 625, an ET nozzle-throat 626, an ET-diffuser 628, an ET-outlet 629, a turbine support 636, and flow straighteners 638. The back-pressure control channel 620 includes a low-pressure region 618.

The apparatus for generating energy 600 may include all or portions of the component(s) of the apparatus for generating energy 100 and/or the apparatus for generating energy 300, depicted in FIG. 1, and/or FIG. 3, respectively, and described above.

In an implementation, low pressure held within the low-pressure region 618 is downstream of the ET-outlet 629. The low pressure of the low-pressure region 618 inside the back-pressure control channel 620 is expected to cause the fluid to move out from the ET-outlet 629 into the back-pressure control channel 620. Low pressure region 618 triggers flow throughout the energy extractor 614, from nozzle-contraction 625 to ET-outlet 629. The fluid is expected to impinge upon the turbine 616, thus causing it to rotate.

The turbine 616 may be mounted on the turbine support 636 which may be attached to the walls (not shown) of the energy extractor 614. Once the flow crosses the turbine 616, it is expected to be turbulent due to interaction with the turbine blades (not shown). In order to smooth the flow of the fluid before it enters the back-pressure control channel 620, one or more flow straighteners 638 may be placed in the ET-diffuser 628. In an implementation, the flow straighteners 638 consist of a series of narrow pathways (not shown) through which the fluid is forced to flow, causing the turbulence to reduce and fluid flow to become relatively laminar.

The first section of the energy extractor 614 may consist of an ET nozzle-contraction 625, which causes the flow to accelerate due to the reducing channel area. The flow is expected to stabilize at the higher flow velocity in the ET nozzle-throat 626. Once past the ET nozzle-throat 626, the fluid may enter the ET-diffuser 628 where it may expand into a larger area channel and slow down again. This convergent-divergent nozzle design is expected to enable greater conversion of the static pressure of the entrained flow into dynamic pressure, which may be used by the turbine 616 to produce mechanical rotation which may be converted to electrical power.

In alternative implementations, the energy extractor 614 may consist of a straight channel with equal area at all points. Therefore, the ET nozzle-contraction 625, ET nozzle-throat 626 and ET-diffuser 628 may be omitted. In some implementations, even the flow straighteners 638 may be eliminated. Note also, while FIG. 6 depicts a single turbine 616 in the energy extractor 614, in other implementations multiple turbines may be installed in parallel, series, or both, in the energy extractor 614. Additionally, in some implementations, the ET-diffuser 628 (or nozzle divergent section) may be configured such that the flow accelerates further instead of slowing down in the ET divergent section, enabling supersonic flow.

In an implementation, the energy extractor 614 is connected to a settlement chamber (not shown) instead of directly to the back-pressure control channel 620. This allows the instabilities introduced by the turbine 616 to be mitigated and energy contained in unstable flows such as vortices to be returned to static pressure in the settlement chamber (not shown) before being drawn into the back-pressure control channel 620 by the low-pressure region 618.

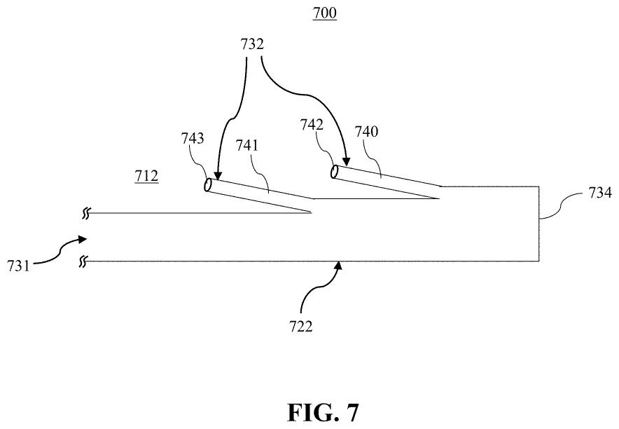

FIG. 7 illustratively depicts a fifth view detailing an apparatus for generating energy 700. FIG. 7 depicts a close-up view of some aspects of FIG. 1 and/or FIG. 2. Specifically, FIG. 7 depicts a close-up view of a pressure ejector and adjacent components. The apparatus for generating energy 700 includes a reservoir of ambient fluid 712 and a pressure ejector (‘PE’) 722. The pressure ejector includes a PE inlet 731, PE outlets 732, a capping wall 734, an outlet channel 740, an outlet channel 741, an outlet opening 742, and an outlet opening 743.

The entrained fluid from the energy extractor (not shown) is expected to flow in from the PE inlet 731. This entrained fluid is expected to be at a lower total pressure than ambient fluid 712 since it has lost some energy to the turbine along its path. As depicted in FIG. 7, flow is expected to travel from left to right. Since the pressure ejector 722 has a capping wall 734, the fluid entering it will be blocked from exiting along the main channel (not shown). As such, a stationary mass of trapped fluid is expected to form inside the pressure ejector 722. As new fluid flows in, it may cause the existing volume to compress which may raise the total pressure of the fluid in the pressure ejector 722 in a pump-like action.

Once the total pressure of the fluid in the pressure ejector 722 rises sufficiently, it is expected to start exiting through the PE outlets 732 through either or both of the outlet opening 742 and/or the outlet opening 743. As such, an equilibrium may form wherein the internal pressure of the fluid inside the pressure ejector 722 is raised to a higher level than the static pressure of the ambient fluid 712, by the pump-like action of the incoming fluid through the PE inlet 731. The rate of fluid entry through the PE inlet 731 and the rate of fluid exit through the PE outlets 732 are expected to equalize such that there is no further net accumulation of fluid in the pressure ejector 722 after a certain point in time. As a result, in this equilibrium state, fluid may enter the pressure ejector 722 at a fixed rate, leaves the pressure ejector 722 at the same rate through the PE outlets 732, while temporarily residing in a trapped stationary state in the pressure ejector 722.

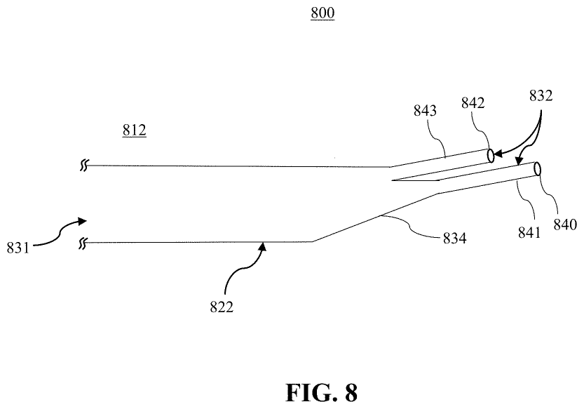

FIG. 8 illustratively depicts a sixth view detailing an apparatus for generating energy 800. FIG. 8 depicts a close-up view of some aspects of FIG. 1 and/or FIG. 2. Specifically, FIG. 8 depicts a close-up view of another pressure ejector and adjacent components. The apparatus for generating energy 800 includes an ambient fluid 812 and a pressure ejector (‘PE’) 822. The pressure ejector includes a PE inlet 831, PE outlets 832, an outlet channel 841, an outlet channel 843, an outlet opening 840, an outlet opening 842, and an end wall 834.

The fluid is expected to flow in from the PE inlet 831. As depicted in FIG. 8, the fluid is expected to travel from left to right. As the fluid travels left to right in the figure, it may be directed by the end wall 834 towards the PE outlets 832. The fluid entering the pressure ejector 822 is expected to have a lower static pressure than the ambient fluid 812. If the fluid entering the pressure ejector 822 has sufficient dynamic pressure, it may overcome the higher static pressure of the ambient fluid 812 and exit from the pressure ejector 822 into the ambient fluid 812 through the PE-outlets 832 without requiring a pressure elevation process.

In an implementation, the PE outlets 832 include at least one of an outlet opening 840 and/or and outlet opening 842 configured to cause the fluid to exit the pressure ejector 822 and return to the ambient fluid 812 without being trapped or delayed. In an alternative implementation, the PE-outlets 832 may include additional outlet openings (not shown).

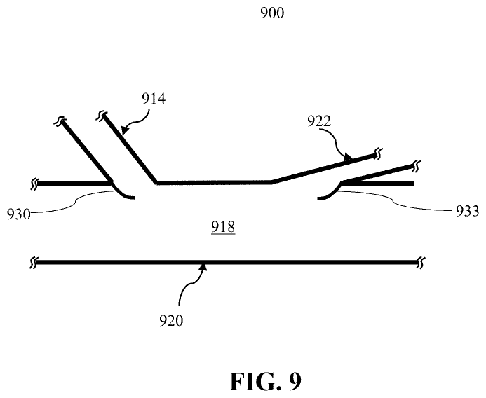

FIG. 9 illustratively depicts a seventh view detailing an apparatus for generating energy 900. FIG. 9 depicts a close-up view of some aspects of FIG. 1 and/or FIG. 2. Specifically, FIG. 9 depicts an ET-BPCC interconnect and adjacent components. The apparatus for generating energy 900 includes an energy extractor 914, a back-pressure control channel 920, and a pressure ejector 922. The back-pressure control channel 920 includes a low-pressure region 918, a flow director vane 930, and a guide vane 933.

Apparatus for generating energy 900 may include all or portions of the component(s) of apparatus for generating energy 100, the apparatus for generating energy 200, the apparatus for generating energy 300, and/or the apparatus for generating energy 400, as depicted in FIG. 1, FIG. 2, FIG. 3, and/or FIG. 4, respectively, and described above.

FIG. 9 depicts the fluid flow area in more detail. The internal structure of the energy extractor 914 and internal structure of pressure ejector 922 is not depicted for economy of space. Entrained flow is expected to enter through the energy extractor 914 into the back-pressure control channel 920 in the low-pressure region 918. In an implementation, this flow is redirected by the flow director vane 930 to become parallel to the back-pressure control channel 920 looping flow. The redirected entrained flow inside the back-pressure control channel 920 then may reach the pressure ejector 922 and may be directed into the pressure ejector 922 by the guide vanes 933. At the same time, the upstream looping flow in the back-pressure control channel 920 is expected to continue along its path within the back-pressure control channel 920 unperturbed.

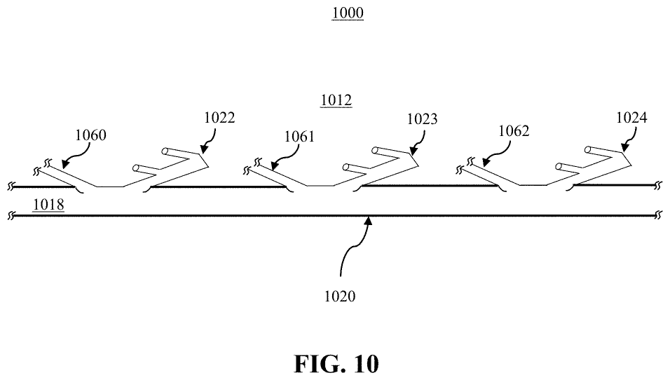

FIG. 10 illustratively depicts an eighth view detailing an apparatus for generating energy 1000. FIG. 10 depicts a close-up view of some aspects of FIG. 1 and/or FIG. 2. Specifically, FIG. 10 depicts a back-pressure control channel and adjacent components. The apparatus for generating energy 1000 includes an ambient fluid 1012, an entry channel 1060, an entry channel 1061, an entry channel 1062, a back-pressure control channel 1020, a pressure ejector 1022, a pressure ejector 1023, and a pressure ejector 1024. The back-pressure control channel includes a low-pressure region 1018.

The apparatus for generating energy 1000 may include all or portions of the component(s) of the apparatus for generating energy 100, the apparatus for generating energy 200, the apparatus for generating energy 300, and/or the apparatus for generating energy 400, depicted in FIG. 1, FIG. 2, FIG. 3, and/or FIG. 4, respectively, and described above.

The apparatus for generating energy 1000 is in fluid contact with a fluid reservoir, from which an ambient fluid 1012 is drawn in through any or all of entry channel 1060, entry channel 1061, and/or entry channel 1062 and into which the ambient fluid 1012 is returned via any or all of pressure ejector 1022, pressure ejector 1023, and/or pressure ejector 1024. The ambient fluid 1012 may be any of air, water, oil, nitrogen, or another Newtonian fluid.

Each of entry channel 1060, entry channel 1061, and entry channel 1062 enables flow to enter from reservoir of ambient fluid 1012. Each of pressure ejector 1022, pressure ejector 1023, and pressure ejector 1024 allows fluid to flow back to the reservoir of ambient fluid 1012. In an implementation, at least two pressure ejectors are configured in a series arrangement, which may allow the same low-pressure region 1018 in the back-pressure control channel 1020 to entrain and process substantially more fluid than with one entry channel and one exit channel. This is expected to enable a larger ratio of entrained flow to flow in the back-pressure control channel 1020. This configuration also possibly enables having higher flow rate for entry channel flow than back-pressure control channel 1020 looping flow.

Each of entry channel 1060, entry channel 1061, and/or entry channel 1062 may be any of energy extractor 102, energy extractor 202, energy extractor 414, energy extractor 514, energy extractor 614, and/or energy extractor 914, as depicted in FIG. 1, FIG. 2, FIG. 4, FIG. 5, FIG. 6, and FIG. 9, respectively. Alternatively, any or all of entry channel 1060, entry channel 1061, and/or entry channel 1062 may feed into a larger channel which forms an energy extractor by merging multiple entry channels. FIG. 10 depicts three entry channels and three pressure ejectors, but in other implementations any number of such pairs might be used.

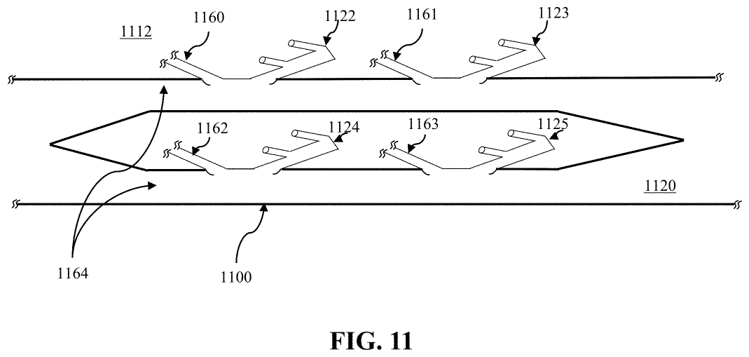

FIG. 11 illustratively depicts a ninth view detailing a component of an apparatus for generating energy 1100. FIG. 11 depicts a close-up view of some aspects of FIG. 1 and/or FIG. 2. Specifically, FIG. 11 depicts a back-pressure control channel and adjacent components. The apparatus for generating energy 1100 includes an ambient fluid 1112, an entry channel 1160, an entry channel 1161, an entry channel 1162, an entry channel 1163, a back-pressure control channel 1120, a pressure ejector 1122, a pressure ejector 1123, a pressure ejector 1124, and a pressure ejector 1125. The back-pressure control channel 1120 includes sub-channels 1164.

The apparatus for generating energy 1100 may include all or portions of the component(s) of the apparatus for generating energy 100, the apparatus for generating energy 200, the apparatus for generating energy 300, and/or the apparatus for generating energy 400, depicted in FIG. 1, FIG. 2, FIG. 3, and/or FIG. 4 respectively, and described above.

The apparatus for generating energy 1100 is in contact with a fluid reservoir (not shown), from which an ambient fluid 1112 is drawn in through any or all of entry channel 1160, entry channel 1161, entry channel 1162, and/or entry channel 1163 and into which the ambient fluid 1112 is returned via any or all of pressure ejector 1122, pressure ejector 1123, pressure ejector 1124, and/or pressure ejector 1125. The ambient fluid 1112 may be any of air, water, oil, nitrogen, or another Newtonian fluid.

In this implementation, the alternate path of the back-pressure control channel 1120 itself splits into one or more sub-channels 1164, such that at least two of the pressure ejectors selected from pressure ejector 1122, pressure ejector 1123, pressure ejector 1124, and/or pressure ejector 1125, are configured in a parallel arrangement. In this implementation, the low-pressure region of the back-pressure control channel 1120 splits cross these sub-channels 1164 as well. In FIG. 11, two such sub-channels 1164 are depicted, but in various implementations, the back-pressure control channel 1120 could split into many parallel sub-channels 1164. Each of the sub-channels 1164 is expected to include entry channels 1160 and alternate paths of pressure ejector 1122 in pairs. FIG. 11 depicts two such “entry channel-PE” pairs, but in other implementations additional sub-channels 1164 and greater or fewer entry channel-PE pairs per each of the sub-channels 1164 may be utilized as well.

While the implementations are susceptible to various modifications and alternative forms, specific examples thereof have been shown in the drawings and are herein described in detail. It should be understood, however, that these implementations are not to be limited to the particular form disclosed, but to the contrary, these implementations are to cover all modifications, equivalents, and alternatives falling within the spirit of the disclosure. Furthermore, any features, functions, steps, or elements of the implementations may be recited in or added to the claims, as well as negative limitations that define the inventive scope of the claims by features, functions, steps, or elements that are not within that scope.

What is claimed is:

1. An apparatus for generating energy, comprising:
a reservoir comprising a fluid;
an energy extractor connected to the reservoir, wherein the energy extractor comprises an energy extraction rotor for extracting energy from the fluid;
a back-pressure control channel coupled to the energy extractor, wherein the back-pressure control channel comprises a fan-like device configured to circulate the fluid and to form a low-pressure region within the back-pressure control channel; and
a pressure ejector coupled to the back-pressure control channel, wherein the pressure ejector is configured to return the fluid to the reservoir.

2. The apparatus for generating energy of claim 1, wherein the back-pressure control channel comprises a first back-pressure control channel, wherein the fan-like device comprises a first fan-like device, wherein the low-pressure region comprises a first low-pressure region, wherein the apparatus for generating energy comprises a second back-pressure control channel coupled to the energy extractor, wherein the second back-pressure control channel comprises a second fan-like device configured to circulate the fluid, and wherein the second fan-like device is further configured to form a second low-pressure region within the second back-pressure control channel.

3. The apparatus for generating energy apparatus of claim 1, wherein the energy extractor comprises a first energy extractor, wherein the energy extraction rotor comprises a first energy extraction rotor, wherein the apparatus for generating energy comprises a second energy extractor coupled to the reservoir, and wherein the second energy extractor comprises a second energy extraction rotor for extracting energy from the fluid.

4. The apparatus for generating energy of claim 1, wherein the energy extractor comprises a nozzle, and wherein the nozzle comprises a variable cross-section.

5. The apparatus for generating energy of claim 4, wherein the variable cross-section is convergent.

6. The apparatus for generating energy of claim 4, wherein the variable cross-section is convergent-divergent.

7. The apparatus for generating energy of claim 4, wherein the variable cross-section is configured to cause the fluid to flow at a flowrate, and wherein the flowrate is subsonic.

8. The apparatus for generating energy of claim 4, wherein the variable cross-section is configured to cause the fluid to flow at a flowrate, and wherein the flowrate is supersonic.

9. The apparatus for generating energy of claim 1, wherein the pressure ejector comprises a capping wall, and wherein the capping wall is configured to at least momentarily trap and delay the fluid as it returns to the reservoir.

10. The apparatus for generating energy of claim 9, wherein the pressure ejector comprises an outlet opening, wherein the outlet opening is configured to cause the fluid to exit the pressure ejector and return to the reservoir.

11. The apparatus for generating energy of claim 6, wherein the variable cross-section comprises a throat, and wherein the variable cross-section is configured such that in response to flow of the fluid a low-pressure is formed in the throat.

12. An apparatus for generating energy, comprising:
a reservoir comprising a fluid;
an energy extractor connected to the reservoir, wherein the energy extractor comprises an energy extraction rotor for extracting energy from the fluid;
a settlement chamber coupled to the energy extractor;
a back-pressure control channel coupled to the settlement chamber, wherein the back-pressure control channel comprises a fan-like device configured to circulate the fluid and to form a low-pressure region within the back-pressure control channel; and
a pressure ejector coupled to the back-pressure control channel, wherein the pressure ejector is configured to return the fluid to the reservoir.

13. The apparatus for generating energy of claim 12, wherein the back-pressure control channel comprises a first back-pressure control channel, wherein the fan-like device comprises a first fan-like device, wherein the low-pressure region comprises a first low-pressure region, wherein the apparatus for generating energy comprises a second back-pressure control channel coupled to the settlement chamber, wherein the second back-pressure control channel comprises a second fan-like device configured to circulate the fluid, and wherein the second fan-like device is further configured to form a second low-pressure region within the second back-pressure control channel.

14. The apparatus for generating energy of claim 12, wherein the settlement chamber comprises a first settlement chamber, wherein the apparatus for generating energy comprises a second settlement chamber.

15. The apparatus for generating energy of claim 12, wherein the energy extractor comprises a first energy extractor, and wherein the energy extraction rotor comprises a first energy extraction rotor, wherein the apparatus for generating energy comprises a second energy extractor coupled to the reservoir, and wherein the second energy extractor comprises a second energy extraction rotor for extracting energy from the fluid.

16. The apparatus for generating energy of claim 12, wherein the pressure ejector comprises a first pressure ejector, wherein the apparatus for generating energy comprises a second pressure ejector coupled to the back-pressure control channel.

17. The apparatus for generating energy of claim 16, wherein the energy extractor comprises a first energy extractor, wherein the apparatus for generating energy comprises a second energy extractor coupled to the reservoir, and wherein the first pressure ejector is coupled to the first energy extractor and the second pressure ejector is coupled to the second energy extractor.

18. The apparatus for generating energy of claim 17, wherein the first pressure ejector and the second pressure ejector are configured in a series arrangement.

19. The apparatus for generating energy of claim 17, wherein the first pressure ejector and the second pressure ejector are configured in a parallel arrangement.

20. The apparatus for generating energy of claim 12, wherein the fluid comprises one of air, water, oil, nitrogen, or another Newtonian fluid.
